(19) United States
(12) Patent Application Publication
(10) Pub. No.: US 2020/0254643 A1
(43) Pub. Date: Aug. 13, 2020

(54) Adjusting Device and Method for Adjusting a Gap Width of a Rotary Punch Device

(71) Applicant: WINK Stanzwerkzeuge GmbH & Co. KG, Neuenhaus (DE)

(72) Inventor: Albertus de Natris, Nordhorn (DE)

(21) Appl. No.: 16/649,641

(22) PCT Filed: Sep. 20, 2018
(86) PCT No.: PCT/EP2018/075514

§ 371 Date: Mar. 21, 2020

(30) Foreign Application Priority Data
Sep. 22, 2017 (DE) 10 2017 122 071.2

(51) Int. Cl. B26D 7/26; B26F 1/38

(52) U.S. Cl. CPC B26D 7/265; B26F 1/384

(57) ABSTRACT

The invention relates to an adjusting device for adjusting the gap width between a punch and counter pressure cylinder of a rotary punch device, comprising an eccentric by means of which the position of a running ring of the counter-pressure cylinder can be adjusted relative to the counter pressure cylinder, and a servomotor which is designed to adjust the gap width between the punch and counter press cylinder. A control device for controlling the servomotor in which an adjusting curve taking into account the eccentricity of the eccentric, is provided. The invention also relates to an associated rotary punch device and to a method for receiving an adjusting curve of an adjusting device and to a method for adjusting a gap width between a punch cylinder and a counter pressure cylinder of a rotary punch machine comprising an adjusting device with an eccentric.

The invention concerns an adjusting device for adjusting the gap width between a punch cylinder and a counter pressure cylinder of a rotary punch device, comprising an eccentric by which the position of a running ring of the counter pressure cylinder can be changed relative to the counter pressure cylinder and a servomotor which is configured for adjusting the gap width between punch cylinder and counter pressure cylinder. Moreover, the invention concerns a rotary punch device comprising a punch cylinder that is rotatable about the punch cylinder axis and a counter pressure cylinder that is rotatable about a counter pressure cylinder axis wherein the counter pressure cylinder comprises running rings on which the punch cylinder or its punch cylinder running rings can run and whose position relative to the punch cylinder can be adjusted by an eccentric.

Such adjusting devices or such rotary punch devices with corresponding adjusting devices are known from the prior art. For example, DE 10 2013 110 510 A1 discloses a device for rotary punching in which the gap width between punch cylinder and counter pressure cylinder is adjustable by means of an eccentric element arranged between punch cylinder running ring and punch cylinder. The adjustment is realized here manually or by means of servomotors.

The gap width between punch cylinder and counter pressure cylinder in conventional rotary punch machines amounts to 480 μm. During punching, punching edges of a punching tool fixed on the punch cylinder are to penetrate the material to be punched as much as possible in order to ensure a good punching result and simple separation of the region to be punched out from the rest of the material. At the same time, it must however be prevented that the punching edges come into contact with the counter pressure cylinder because these components would thus be damaged. In order to ensure this, the gap width between punch cylinder and counter pressure cylinder is configured to be adjustable. Thus, manufacturing tolerances of the punch cylinder or of the counter pressure cylinder as well as of the punching tool can be taken into account. Moreover, a readjustment of the gap width is required upon wear of the relevant components such as punch cylinder, counter pressure cylinder or the running rings or wear of the punching tool. This adjustment of the gap width must be possible very precisely in order to ensure a good punching result and prevent at the same time that the punch machine or the punching tool becomes damaged.

A disadvantage of an adjusting device or of a rotary punch machine with this adjusting device according to the prior art is that, in particular in devices with eccentrics, the reliable adjustment of an exact gap width due to wear of the device, which may be within a magnitude relevant in regard to a readjustment, is possible only with difficulty, in particular in case of adjusting devices that are to be manually actuated.

Object of the present invention is to improve an adjusting device or a rotary punch system of the aforementioned kind in such a way that the gap width between punch cylinder and counter pressure cylinder can be reliably exactly adjusted.

According to the invention, this is achieved in that the servomotor of the adjusting device has correlated therewith a control device configured for controlling the servomotor in which an adjusting curve is stored which takes into account the eccentricity of the eccentric, or the rotary punch device comprises an adjusting device according to the invention with which the gap width between punch cylinder and counter pressure cylinder can be changed.

The adjusting curve can be stored in the control device so as to be unchangeable; however, more advantageous is a changeable storage in a rewritable memory region of the control device.

Furthermore, a method for recording an adjusting curve of an adjusting device of a rotary punch device as well as a method for adjusting a gap width between a punch cylinder and a counter pressure cylinder of a rotary punch device with an adjusting device that comprises an eccentric is subject matter of the invention.

The rotation of the eccentric effects, depending on the configuration of the eccentric, a sine-shaped or cosine-shaped displacement of the punch cylinder axis relative to the counter pressure cylinder axis in two spatial directions which are perpendicular to each other and perpendicular to the punch cylinder axis or counter pressure cylinder axis. Based on the cylinder shape of the punch cylinder and counter pressure cylinder, a non-linear and in particular not simply a sine-shaped or cosine-shaped change of the gap width between punch cylinder and counter pressure cylinder results in this context. By means of an adjusting curve which is stored in the control device, this fact can be taken into account when adjusting the gap width by means of a servomotor. In this context, the adjusting curve can be based either on a precisely determined function of the correlation between the rotation of the eccentric and the change of the gap width or can be stored in the form of discrete support points between which the real function is approximated by interpolation, for example, linear interpolation. In this way, the adjusting device or a rotary punch machine furnished with the adjusting device enables a very precise and repeatable adjustment of the desired gap width. Due to the adjusting curve, a servomotor-side movement for adjusting the gap width corresponds linearly to an adjustment of the gap width.

Moreover, due to a high precision of the system which is, for example, embodied with a step motor and a system that is further self-locking by means of a worm gear, a very low displacement of the adjusting device during operation can be realized compared to conventional systems.

Advantageously, the adjusting device comprises a position determination unit which is configured to transmit the position of the eccentric to the control device. Since the displacement of the punch cylinder axis relative to the counter pressure cylinder axis is realized in a sine shape or cosine shape in the two described spatial directions which are perpendicular to each other and to the punch cylinder axis and counter pressure cylinder axis, the displacement of the axes resulting from a defined rotation of the eccentric element depends on the initial position of the eccentric. Due to the position determination unit, the initial or end position of the eccentric can be transmitted to the control device and be the basis when taking into account the eccentricity of the eccentric by means of the adjusting curve. The position determination unit can be embodied, for example, as an optical, electric or magnetic sensor, as a feeler or as a counter wheel. However, other sensors which can be used for position determination of the eccentric are also suitable in principle. In this way, the reliability and precision of the adjustment of the gap width between punch cylinder and counter pressure cylinder is improved and the movement can be reversed unambiguously.

Due to the position determination unit, an unambiguous return into the desired initial state can be realized after an already minimal adjustment caused by the operation because of the existing linear correlation.

In particular, a magnet can be arranged on a toothed wheel which is non-rotatably connected to the eccentric while the magnetic sensor on the part of the actuating means that moves the toothed wheel is arranged on or in the housing of the worm gear, for example. In such a configuration, a zero position can be identified by means of the magnetic sensor in the position determination unit.

Particularly preferred, the control device is configured to adjust, upon change of the gap width by a defined adjusting width parameter, the control parameter for the servomotor as a function of the position of the eccentric by means of the adjusting curve. In this context, the control device determines, based on the actual position of the eccentric, the actual gap width as well as the new gap width based on the adjusting width parameter, inasmuch as the adjusting width parameter has not already been specified by the specification of the desired final gap width. Moreover, based on the adjusting curve, either the required control parameter for the servomotor can be determined directly or, for example, the required rotation of the eccentric and thereby the required control parameter for the servomotor can be determined. In this way, the reliability and precision of the adjustment of the gap width is further improved.

Due to the control device according to the invention, the machine can be newly calibrated, preferably in an automated fashion, upon surpassing in particular predeterminable wear limits.

Particularly preferred, the control device is configured to adjust the control parameter in such a way that, independent of the position of the eccentric, a gap width adjustment according to the adjusting width parameter is realized always.

Preferably, the servomotor is configured as a step motor. Due to the configuration of the servomotor as a step motor, a rotation of the eccentric can be realized reliably, precisely, and repeatably. This improves the reliability of the gap width adjustment by the adjusting device according to the invention or in a rotary punch device provided with the adjusting device. Particularly preferred, the control device comprises an encoder which records the steps of the step motor. Recording the steps of the step motor can be directly or indirectly realized in this context. In case of the direct recording, the encoder records the number of performed steps. Indirectly, the encoder can record the adjusting pulses which are transmitted to the step motor wherein for each adjusting pulse an adjustment of the step motor by a fixed number of steps is realized. In this way, it can be ensured that the adjustment by the step motor is realized in accordance with the control signal of the control device. The desired gap width is reliably adjusted.

Particularly preferred, the encoder is configured as a position determination unit. In this context, the encoder transmits the sum, resulting from counting the steps of the step motor or the pulses for controlling the step motor, to the control unit wherein the steps in one direction are counted as positive and in the other direction as negative. Since the step motor is connected to the eccentric directly or by means of a gear with low clearance and high repeating precision in order to provide for an exact adjustment of the eccentric, the actual position of the eccentric can be determined based on the sum of the steps of the step motor or of the pulses controlling the step motor. The position determination can thus be realized in a simple but still reliable manner; a separate reference position determination unit is therefore not needed.

Preferably, the eccentric comprises a toothed rim extending at least halfway, preferably at least almost completely and in particular completely, about the circumference, by means of which the eccentric is positionable, in particular rotatable. By means of the at least halfway circumferentially extending toothed rim a sufficiently large, and by means of an almost completely circumferentially extending one, a broad adjusting range of the eccentric is enabled. In addition, a toothed rim can be positioned precisely on the eccentric in a comparatively easy way. In this way, the precise and repeatable positioning of the eccentric is increased.

The adjusting unit comprises preferably two eccentrics on oppositely positioned sides of the counter pressure cylinder. In this way, a uniform adjustment of the gap width across the entire width of the gap between punch cylinder and counter pressure cylinder is enabled.

Preferably, the adjusting device comprises a positioning unit with a toothed wheel corresponding to the toothed rim of the eccentric. The adjusting unit is arranged such in this context that the toothed wheel of the adjusting unit meshes with the toothed rim of the eccentric. In this context, the toothed wheel can be driven directly or by means of a gear by the servomotor. Particularly preferred, the toothed wheel is non-rotatably connected to a toothed gear. In this context, the toothed gear is driven by the servomotor. Due to the use of toothed gears, a high repeatability and positioning precision of an adjustment of the eccentric is enabled. Due to the toothed gear, furthermore a step-up gearing or gear reduction of the rotation of the servomotor relative to the rotation of the eccentric can be realized. Particularly preferred, the toothed gear is configured as a self-locking worm gear. In this context, preferably the worm gear is connected non-rotatably to the toothed wheel and the worm is driven by the servomotor. The self-locking worm gear prevents a rotation of the eccentric after it has been displaced by the servomotor into the desired position. In this way, the reliability of the adjusting device is increased and the load on the servomotor is reduced. As a whole, the reliability of the adjusting device is increased in this way.

Preferably, the toothed wheel in combination with the toothed rim and/or the toothed gear and/or the combination toothed wheel/worm wheel are configured as a gear assembly reducing a rotational movement of the step motor. The reduction gear has the result that a rotation of the step motor causes only a very minimal rotation of the eccentric. In this way, a very precise positioning of the eccentric and thus a very precise adjustment of the gap width in the range of preferably tenths of μm is possible. However, also adjustment steps in the range of hundredths of μm is possible.

The object of the invention is furthermore solved by a rotary punch device comprising a punch cylinder that is rotatable about a punch cylinder axis and a counter pressure cylinder that is rotatable about a counter pressure cylinder axis, wherein the counter pressure cylinder comprises running rings on which the punch cylinder or its punch cylinder running rings can run and whose position relative to the punch cylinder is changeable by an eccentric, wherein the adjusting device is configured as described above or in the following and in particular a gap width between punch cylinder and counter pressure cylinder is adjustable by the adjusting device. The advantages described above and in the following are associated with this rotary punch device.

Furthermore, the object is solved by a method for recording an adjusting curve, in particular of an adjusting device according to the invention of a rotary punch machine. The method according to the invention is characterized in that a gap width between a punch cylinder and a counter pressure cylinder is varied by means of the rotation of an eccentric by means of which the position of a running ring of the counter pressure cylinder relative to the counter pressure cylinder can be changed. In different rotational positions of the eccentric, the gap width of the rotary punch machine is measured and, based on the data in regard to the rotational position of the eccentric and the gap width, the adjusting curve is determined which is stored in a control device of a servomotor of the adjusting device. The measurement of the gap width can be recorded in this context by means of one or a plurality of sensors arranged in the gap or detecting the gap, in particular by one or a plurality of optical sensors passing light through the gap.

For the gap width, either the value of one sensor is used or the values of several different sensors are averaged. Moreover, the rotational position of the eccentric is ideally determined according to the same method as it would be determined also in the future operation by the control device. Based on this, data points are determined that comprise the gap width and the position of the eccentric or a measured parameter describing the position of the eccentric. The adjusting curve can now be exactly determined either based on the geometric correlation to be determined between gap width and rotation of the eccentric or completed by interpolation, for example, by linear interpolation, between the individual discrete value pairs that have been metrologically determined.

Moreover, a method for adjusting a gap width between a punch cylinder and a counter pressure cylinder of a rotary punch machine with an adjusting device comprising an eccentric is subject matter of the present invention. The method is characterized in that an adjusting width parameter is transmitted to a control device of a servomotor of the adjusting device and is converted by means of an adjusting curve into a control signal for the servomotor. In this context, the eccentricity of the eccentric is taken into account for determining the control signal for the servomotor by means of the adjusting curve. In this way, a precise adjustment of the gap width that takes into account the eccentricity of the eccentric is enabled.

In particular for a highly precise step motor that enables a precision in regard to adjustment of 1 μm, a quasi continuous constant adjustment can be carried out automatically even in case of wear.

Particularly preferred, the method comprises a step in which a position determination unit records position data of the eccentric and transmits them to the control unit, wherein in the control unit, as a function of the position of the eccentric of the adjusting device, the adjusting width parameter is converted into a control signal for the servomotor. In this way, the determination of the control signal for the servomotor is based on the precise actual position of the eccentric, and the precision and repeatability of the adjustment of the gap width is increased. Particularly preferred, an adjustment of the gap width according to the method of the present invention is carried out always exactly according to the adjusting width parameter independent of the position of the eccentric. In this way, the reliability of the method is increased in which an adjustment of the gap width is realized reliably in accordance with the specifications.

Further advantageous embodiments of the invention will be explained in more detail with the aid of the embodiment described in the following. It is shown in:

FIG. 1 a counter pressure roll with the adjusting device according to the invention;

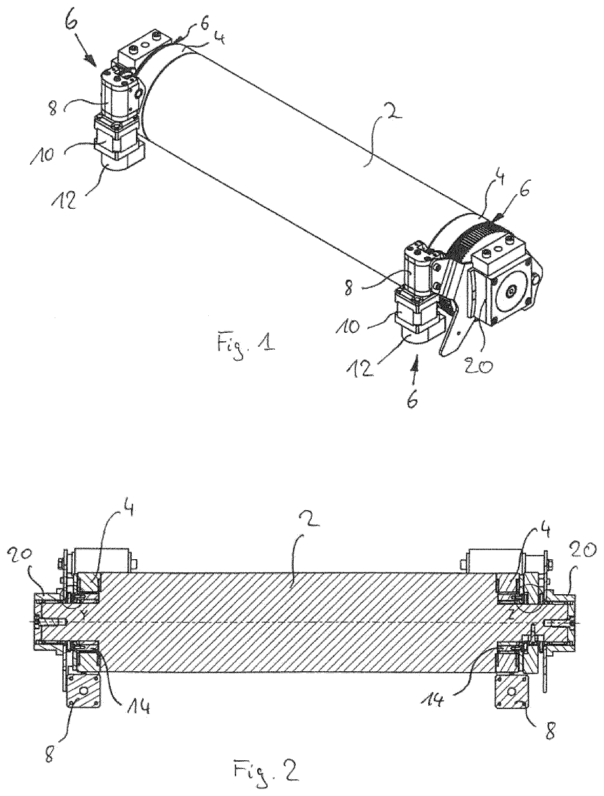

FIG. 2 a cross section of the counter pressure roll according to FIG. 1;

FIG. 3 a positioning unit of the adjusting device according to the invention;

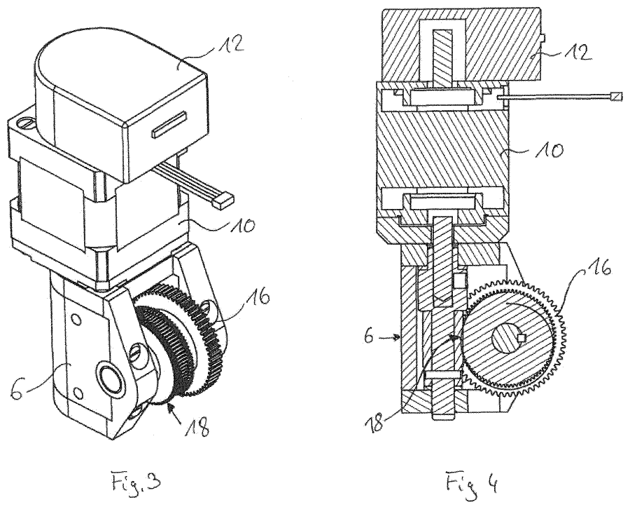

FIG. 4 a cross section of the positioning unit according to FIG. 3;

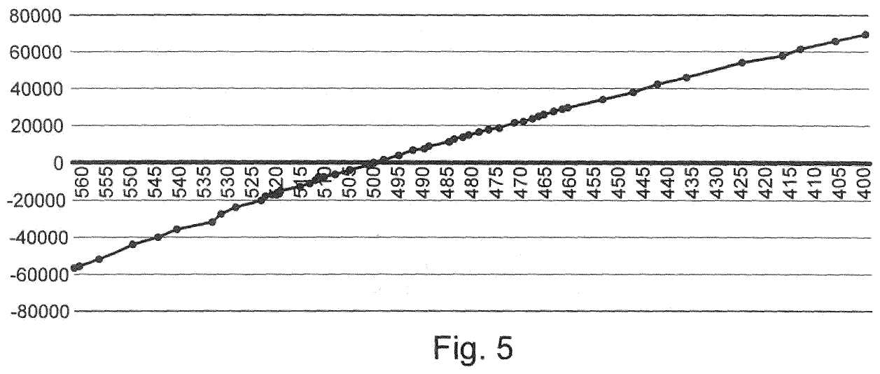

FIG. 5 an adjusting curve of an article according to the invention.

In the following, elements of the invention that are acting in the same way are provided with the same reference number. The features of the embodiment described in the following can also be subject matter of the invention in other feature combinations than illustrated.

FIG. 1 shows a counter pressure cylinder 2 with two running rings 4 whose position relative to the counter pressure cylinder 2 can be adjusted by means of an adjusting device 6, respectively, which each a positioning unit 8, comprising a servomotor 10 and an encoder 12.

In FIG. 2, the counter pressure cylinder 2 is illustrated in cross section. At both ends of the counter pressure cylinder 2 an adjusting device 6 is arranged in which an eccentric 14 is arranged between counter pressure cylinder 2 and running ring 4. The eccentric 14 comprises a round bore as well as a round outer surface wherein the center points of the circles of the inner bore as well as of the outer circle are displaced relative to each other. Moreover, the positioning units 8 correlated with the adjusting units 6 can be seen.

The positioning unit 8 is illustrated in FIG. 3. It comprises the servomotor 10 embodied as a step motor as well as the encoder 12, which can be used also as a position determination unit, as well as the toothed wheel 16 which, in operation, is in engagement with the toothed rim of the eccentric 14 and a worm wheel of the worm gear 18 (FIG. 4). The worm gear can be seen in section view through the positioning unit 8 in FIG. 4. In this context, the worm of the worm gear 18 is driven by the servomotor 10.

For a control of the adjustment that is as much as possible unaffected by the frame construction of a rotary punch device, the support of the counter pressure cylinder 2 is arranged in slide blocks 20 which are slidably arranged within the frame construction.

An exemplary adjusting curve shows on its X axis the gap width and on its Y axis the number of steps of the step motor required for the adjustment of the gap width, beginning at the zero position at 500 μm in one or the other direction (FIG. 5).

What is claimed is:

1.-17. (canceled)

18. An adjusting device for adjusting a gap width between a punch cylinder and a counter pressure cylinder of a rotary punch device, the adjusting device comprising:
an eccentric comprising an eccentricity and configured to change a position of a running ring of the counter pressure cylinder relative to the counter pressure cylinder;
a servomotor configured to adjust the gap width between the punch cylinder and the counter pressure cylinder;
a control device configured to control the servomotor and having an adjusting curve stored therein, wherein the adjusting curve is configured to take into account the eccentricity of the eccentric.

19. The adjusting device according to claim 18, further comprising a position determination unit configured to transmit a position of the eccentric to the control device.

20. The adjusting device according to claim 19, wherein the control device is configured to adjust, upon a change of the gap width by an adjusting width parameter, a control parameter for the servomotor based on the adjusting curve as a function of the position of the eccentric, transmitted by the position determination unit to the control device.

21. The adjusting device according to claim 20, wherein the control device is configured to adjust the control parameter such a gap width adjustment according to the adjusting width parameter is always realized independent of a position of the eccentric.

22. The adjusting device according to claim 18, wherein the servomotor is a step motor.

23. The adjusting device according to claim 22, wherein the control device comprises an encoder configured to record steps of the step motor.

24. The adjusting device according to claim 23, wherein the encoder is configured as a position determination unit.

25. The adjusting device according to claim 18, wherein the eccentric comprises a toothed rim which extends at least halfway circumferentially about the eccentric, wherein the toothed rim is configured to position the eccentric.

26. The adjusting device according to claim 25, further comprising a positioning unit with a toothed wheel interacting with the toothed rim.

27. The adjusting device according to claim 26, further comprising a toothed gear, wherein the toothed wheel is non-rotatably connected to the toothed gear.

28. The adjusting device according to claim 27, wherein the toothed gear is a self-locking worm gear.

29. The adjusting device according to claim 27, wherein the toothed wheel in combination with the toothed gear is configured as a reduction gear for a rotational movement of the servomotor.

30. The adjusting device according to claim 27, wherein the toothed wheel in combination with the toothed rim and the toothed gear is configured as a reduction gear for a rotational movement of the servomotor.

31. The adjusting device according to claim 26, wherein the toothed wheel in combination with the toothed rim is configured as a reduction gear for a rotational movement of the servomotor.

32. A rotary punch device comprising:
a punch cylinder rotatable about a punch cylinder axis;
a counter pressure cylinder rotatable about a counter pressure cylinder axis;
an adjusting device according to claim 1, wherein the gap width between the punch cylinder and the counter pressure cylinder is changeable by the adjusting device, wherein the counter pressure cylinder comprises running rings configured to support the punch cylinder or punch cylinder running rings of the punch cylinder and wherein the eccentric of the adjusting device is configured to change a position of the running rings of the counter pressure cylinder relative to the counter pressure cylinder and relative to the punch cylinder.

33. A method for recording an adjusting curve of an adjusting device according to claim 1, the method comprising:
varying a gap width between a punch cylinder and the counter pressure cylinder by a rotation of the eccentric that is configured to change the position of the running ring of the counter pressure cylinder relative to the counter pressure cylinder;
measuring the gap width in a plurality of different rotational positions of the eccentric;
determining the adjusting curve based on data measured in the step of measuring regarding the different rotational positions of the eccentric and the gap width associated with the rotational positions; and
storing the adjusting curve in the control device of the servomotor of the adjusting device.

34. A method for adjusting a gap width between a punch cylinder and a counter pressure cylinder of a rotary punch device with an adjusting device comprising an eccentric, the method comprising:
transmitting an adjusting width parameter to a control device of a servomotor of the adjusting device;
converting the adjusting width parameter, based on an adjusting curve stored in the control device, into a control signal for the servomotor.

35. The method according to claim 34, further comprising:
recording position data of the eccentric with a position determination unit and transmitting the position data to the control device; and
converting the adjusting width parameter in the control device as a function of the position data of the eccentric into the control signal for the servomotor.

36. The method according to claim 35, wherein an adjustment of the gap width according to the adjusting width parameter is always realized independent of a position of the eccentric.
